(19) United States
(12) Patent Application Publication
(10) Pub. No.: US 2025/0260794 A1
(43) Pub. Date: Aug. 14, 2025

(54) ELECTRONIC DEVICE AND METHOD FOR CONTROLLING SAME

(71) Applicant: SAMSUNG ELECTRONICS CO., LTD., Suwon-si (KR)

(72) Inventors: Jiyeon MA, Suwon-si (KR); Kihyoung SON, Suwon-si (KR); Jingun JUNG, Suwon-si (KR); Sungjun HWANG, Suwon-si (KR); Youngah LEE, Suwon-si (KR)

(73) Assignee: SAMSUNG ELECTRONICS CO., LTD., Suwon-si (KR)

(21) Appl. No.: 19/193,288

(22) Filed: Apr. 29, 2025

Related U.S. Application Data
(63) Continuation of application No. PCT/KR2023/014275, filed on Sep. 20, 2023.

(30) Foreign Application Priority Data
Nov. 9, 2022 (KR) 10-2022-0148475

(51) Int. Cl. H04N 9/31; G06F 3/01; G06F 3/04845

(52) U.S. Cl. CPC H04N 9/3185; G06F 3/016; G06F 3/04845

(57) ABSTRACT

An electronic including a camera; a display; a communication interface; a memory; and one or more processors. The display displays an image obtained by the camera according to a projection surface on which a test image including a plurality of markers is projected, when first information indicating positions of the plurality of markers and second information indicating the position of a maximum projection area are received from a projector device. The processor(s) obtains fourth information indicating the position of the maximum projection area within the obtained image based on the first information, the second information, and third information based on the obtained image. A guide GUI guiding the projection area is displayed based on the obtained fourth information; and keystone correction information for projecting an image corresponding to the guide area corresponding to the guide GUI is transmitted to the projector device through the communication interface.

### CROSS-REFERENCE TO RELATED APPLICATION

This application is a continuation application is a continuation application, under 35 U.S.C. $111 (a), of international application No. PCT/KR2023/014275, filed Sep. 20, 2023, which claims priority under 35 U. S. C. § 119 to Korean Patent Application No. 10-2022-0148475, filed Nov. 9, 2022, the disclosures of which are incorporated herein by reference in their entireties.

### TECHNICAL FIELD

The present disclosure relates to an electronic device and a method for controlling the same, and more particularly, to an electronic device that projects an image and a method for controlling the same.

### BACKGROUND ART

Recently, various projectors have been used in accordance with the development of electronic and optical technologies. The projector indicates an electronic device that projects light onto a projection surface (or projection screen) to form an image on the projection surface.

In case of projecting an image by using the projector, if the projector is placed straight on a flat surface toward the projection surface, a rectangular image may be displayed on the projection surface. Otherwise, distortion may occur in up and down or left and right, or a rotated image may appear on the projection surface. This distortion may be referred to as a keystone effect.

Conventionally, the projector captures the projection surface by using an image sensor, then processes the captured image to calculate a misaligned angle between the projection surface and the projector, and uses the result. In this case, a correction process is required to be performed to align an optical axis of the projector with a measurement axis of the image sensor. If an error occurs in this correction process, the error may significantly affect the angle calculation. In addition, a process of processing the image captured by the image sensor may also require a lot of calculations.

### DISCLOSURE

### Technical Solution

According to an embodiment of the present disclosure, provided is an electronic device including: a camera; a display; a communication interface; a memory to store at least one instruction; and at least one processor, to be connected to the camera, the display, the communication interface, and the memory, and while connected, the at least one processor is configured to control the electronic device. The at least one processor is configured to control the display to display an image captured by the camera based on a projection surface onto which a test image including a plurality of markers is projected being captured by the camera, acquire fourth information indicating a position of a maximum projection area within the captured image based on first information, second information, and third information. The first information may indicate positions of the plurality of markers and the second information may indicate the position of the maximum projection area are received from a projector device via the communication interface and the third information may be based on the captured image. The at least one processor is configured to control the display to display a guide graphical user interface (GUI) guiding a projection area based on the acquired fourth information, and acquire keystone correction information, which enables projection of an image corresponding to a guide area corresponding to the guide GUI, to be transmitted to the projector device via the communication interface.

The fourth information may include coordinate information of a four-vertex area indicating the position of the maximum projection area, the at least one processor may be configured to display the guide GUI without deviating from the maximum projection area based on the fourth information, environmental information included in the captured image, and a predetermined projection area ratio, and the guide GUI may have a rectangular line shape.

The at least one processor may be configured to control the communication interface to transmit spatial information from which the keystone correction information is acquired to the projector device together with the keystone correction information, and the spatial information may include information on a distance between the projector device and the electronic device and information on a direction of the electronic device relative to the projector device.

The at least one processor may be configured to acquire the keystone correction information for the projection screen relatively close to the electronic device among the plurality of projection screens if the test image included in the captured image includes the plurality of projection screens, and the plurality of projection screens may respectively provide a plurality of first content provided from a plurality of sources or a plurality of second content provided from a single source.

The at least one processor may be configured to acquire the keystone correction information for any one of the projection screens regardless of a distance between the plurality of projection screens and the electronic device if the any one of the plurality of projection screens includes content provided from the electronic device.

The at least one processor may be configured to control the display to display a user interface (UI) screen for adjusting magnification of at least one of a first projection area corresponding to a first projector device and a second projection area corresponding to a second projector device if the captured image including a first test image projected from the first projector device and a second test image projected from the second projector device is acquired, and acquire the keystone correction information for adjusting the magnification of the first projection area and the second projection area to the same level based on a user command input through the UI screen.

The at least one processor may be configured to control the display to provide a UI guiding a position movement of at least one of the first projector device or the second projector device if the first projection area and the second projection area are identified as being incapable of overlapping with each other.

The at least one processor may be configured to control the display to display a first guide GUI guiding a current projection area and a second guide GUI guiding the maximum projection area, and provide feedback on an adjustable area of the first guide GUI based on the second guide GUI if at least one of the size, position, or direction of the first guide GUI is adjusted based on a user command, and the feedback may include at least one of visual feedback, sound feedback, or haptic feedback.

The at least one processor may be configured to identify a position of an object included in the captured image, and control the display to display the adjusted guide GUI that is automatically adjusted based on the position of the identified object if at least one of the size or position of the guide GUI is manually adjusted by a user input.

The device may further include a sensor, wherein the at least one processor is configured to correct the guide GUI or provide the guide UI based on at least one of environmental information of the projection surface or posture information of the electronic device, acquired through the sensor.

According to an embodiment of the present disclosure, provided is a method for controlling an electronic device, the method including: displaying an image captured by a camera based on a projection surface onto which a test image including a plurality of markers is projected is captured by the camera; acquiring fourth information indicating a position of a maximum projection area within the captured image based on first information, second information, and third information, the first information indicating positions of the plurality of markers, the second information indicating the position of the maximum projection area are received from a projector device and the third information based on the captured image; displaying a guide graphical user interface (GUI) guiding a projection area based on the acquired fourth information; and acquiring keystone correction information, which enables projection of an image corresponding to a guide area corresponding to the guide GUI, to be transmitted to the projector device.

According to an embodiment of the present disclosure, provided is a non-transitory computer-readable medium storing a computer instruction that causes an electronic device to perform an operation when executed by a processor of the electronic device, the operation includes displaying an image captured by a camera based on a projection surface onto which a test image including a plurality of markers is projected is captured by the camera, acquiring fourth information indicating a position of a maximum projection area within the captured image based on first information, second information, and third information, the first information indicating positions of the plurality of markers, the second information indicating the position of the maximum projection area are received from a projector device and the third information based on the captured image, displaying a guide graphical user interface (GUI) guiding a projection area based on the acquired fourth information, and acquiring keystone correction information, which enables projection of an image corresponding to a guide area corresponding to the guide GUI, to be transmitted to the projector device.

### DESCRIPTION OF DRAWINGS

FIGS. 1A and 1B are diagrams for describing concepts of a keystone correction method and a coordinate system to assist understanding.

FIG. 2A is a block diagram showing a configuration of an electronic device according to an embodiment.

FIG. 2B is a block diagram showing a specific configuration of an electronic device according to an embodiment.

FIG. 3 is a diagram for describing a method for controlling an electronic device according to an embodiment.

FIGS. 4A, 4B, 5A, and 5B are diagrams for describing a method for acquiring keystone correction information according to an embodiment.

FIG. 6 is a diagram for describing one scenario of a method for providing auto keystone according to an embodiment.

FIGS. 7A, 7B, 8A, and 8B are diagrams for describing a method for providing the keystone correction information according to an example of an embodiment.

FIGS. 9, 10, 11A, 11B, 12A, and 12B are diagrams for describing a keystone correction method for a plurality of projection screens according to an embodiment.

FIGS. 13, 14A, 14B, and 14C are diagrams for describing the keystone correction method in case of using a plurality of projector devices according to an embodiment.

FIG. 15 is a diagram for describing a scenario in case of using the plurality of projector devices according to an embodiment.

FIGS. 16, 17, 18A, and 18B are diagrams for describing a method for adjusting the projection screen using user interaction according to an embodiment.

FIGS. 19 and 20 are diagrams for describing a method for adjusting the projection screen based on a surrounding environment according to an embodiment.

### BEST MODE

Hereinafter, the present disclosure is described in detail with reference to the accompanying drawings.

Terms used in this specification will be briefly described, and the present disclosure will then be described in detail.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

Terms “first”, “second”, and the like, may be used to describe various components. However, the components are not to be construed as being limited to these terms. The terms are used only to distinguish one component and another component from each other.

A term of a singular number may include its plural number unless explicitly indicated otherwise in the context. It should be understood that a term “include” or “formed of” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

An expression, “at least one of A or/and B” may indicate either “A or B”, or “both of A and B.”

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by at least one processor (not shown) except for a “module” or a “˜er/or” that needs to be implemented by a specific hardware.

Hereinafter, the embodiments of the present disclosure are described in detail with reference to the accompanying drawings so that those skilled in the art to which the present disclosure pertains may easily practice the present disclosure. However, the present disclosure may be modified in various different forms, and is not limited to the embodiments provided in the specification. In addition, in the drawings, portions unrelated to the description are omitted to clearly describe the present disclosure, and similar portions are denoted by similar reference numerals throughout the specification.

Hereinafter, the embodiments of the present disclosure are described in detail with reference to the accompanying drawings.

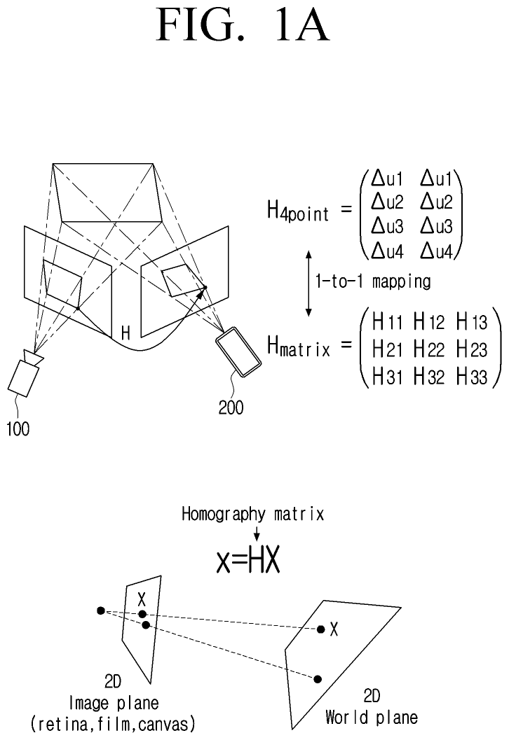

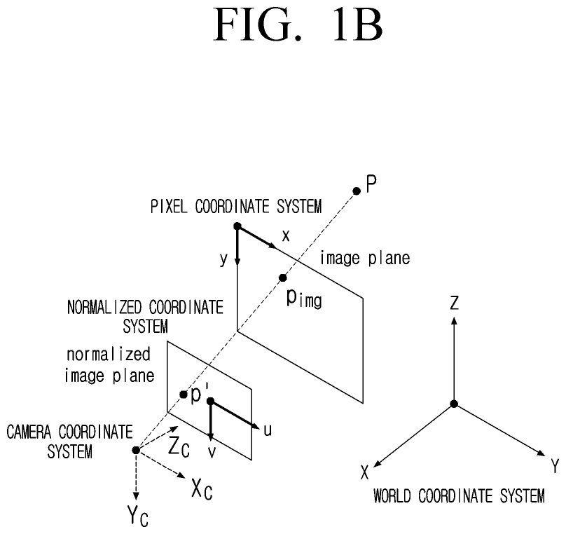

FIGS. 1A and 1B are diagrams for describing concepts of a keystone correction method and a coordinate system to assist understanding.

An electronic device 100 equipped with a function for projecting an image, that is, a projector function, shows a screen having a relatively accurate ratio if a projector is positioned on a straight line relative to a projection surface. However, the electronic device 100 may show a screen deviating from the projection surface or project a diamond-shaped screen distorted up, down, left, or right if the projector is not positioned on the straight line relative to the projection surface due to a spatial condition. In this case, keystone correction may be required. Here, the keystone correction may indicate a function for adjusting the screen being displayed, that is, the screen being projected, by forcibly moving the corners of a projected projection screen to make the screen closer to its original rectangular shape.

According to an embodiment, the keystone correction may be performed using a user terminal 200 as shown in FIG. 1A. For example, a projection surface 10 onto which the image is projected may be captured using a camera included in the user terminal 200, and the keystone correction may be performed on the basis of the captured image. Here, Projective Transformation may be used. Projective Transformation indicates a transformation that projects an image in a three-dimensional (3D) space into a two-dimensional (2D) space. That is, Projective Transformation indicates a method for transforming two images viewed from two different viewpoints in the 3D space. Here, a matrix representing a relationship between two different images may be referred to as homography matrix (hereinafter, referred to as H matrix). For example, a size of H matrix may be 3×3. Four corresponding pair coordinates may be required to acquire H matrix. As an example, the four corresponding pair coordinates may be coordinates on a world coordinate system.

FIG. 1B is the diagram for describing the concept of the coordinate system to assist the understanding.

As shown in FIG. 1B, four coordinate systems may be present in image geometry: the world coordinate system, a camera coordinate system, a normalized coordinate system, and a pixel coordinate system. Here, the world coordinate system and the camera coordinate system may be 3D coordinate systems, and the normalized coordinate system and the pixel coordinate system may be 2D coordinate systems.

The world coordinate system may be a coordinate system that is used as a reference in case of representing a position of an object. The world coordinate system may be a coordinate system that may be arbitrarily selected and used. For example, the world coordinate system may take one corner of the space as its origin, a direction of one wall as an X-axis, a direction of the other wall as a Y-axis, and a direction toward the sky as a Z-axis. A point on the world coordinate system may be represented as P(X, Y, Z).

The camera coordinate system may be a coordinate system based on the camera. The camera coordinate system may take a focus of the camera (or the center of a lens) as its origin, a front optical axis direction of the camera as the Z-axis, a downward direction of the camera as the Y-axis, and rightward direction of the camera as the X-axis. A point on the camera coordinate system may be represented as Pc(Xc, Yc, Zc).

The pixel coordinate system may be referred to as an image coordinate system. The pixel coordinate system may be a coordinate system for an image that is actually seen with the eyes, and may take an upper left corner of the image as its origin, a rightward direction of the image as an x-axis increasing direction, and a downward direction of the image as a y-axis increasing direction. In addition, a plane determined by the x-axis and y-axis of the pixel coordinate system may be referred to as an image plane.

Geometrically, a point P=(X, Y, Z) in the 3D space may be projected onto a point p_{img}=(x, y) on the image plane by passing through the focus of the camera (or a focus of the lens). All 3D points on a line (or ray) connecting point P and point p_{img} may be projected onto p_{img}. Therefore, p_{img} may be uniquely determined from the 3D point P. However, conversely, it is impossible to acquire P from the image pixel p_{img} without additional information. A unit of the pixel coordinate system is a pixel, which may be represented as p_{img}=(x, y).

The normalized coordinate system (or normalized image coordinate system) may be an image coordinate system that eliminates an influence of internal parameters of the camera. In addition, the normalized coordinate system may be a coordinate system that eliminates a unit of the (normalized) coordinate system and defines a virtual image plane whose distance from the focus of the camera is 1. That is, the virtual image plane may be an image plane that is moved to a point where the distance from the camera focus is 1 by translating an original image plane. The origin of the normalized coordinate system may be the center of the image plane (or a point of intersection with the optical axis Zc). A point on the normalized coordinate system may be represented as p′=(u, v). Even if the same scene is captured from the same position and angle, different images may be acquired depending on the camera used or a camera setting. A normalized image plane may be used because it is more effective to analyze common geometric characteristics and establish theories in the normalized image plane that eliminates these factors.

Meanwhile, the shape or material of the projection surface may have a great influence on the distortion or quality of an output image, and it may be difficult for the projector to perform the keystone correction without distortion on its own.

Accordingly, hereinafter, the description describes the various embodiments that perform the keystone correction accurately to project the image onto an optimal area desired by a user using an image captured by the electronic device 100.

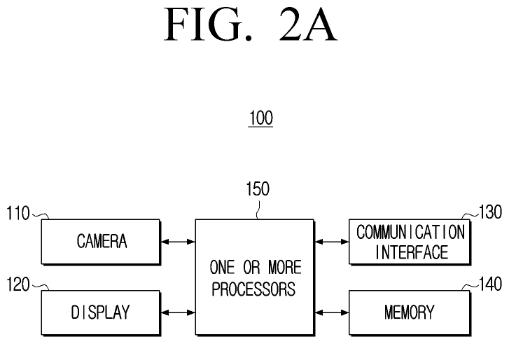

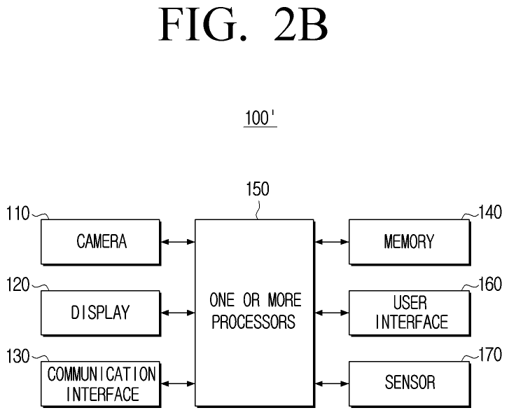

FIG. 2A is a block diagram showing a configuration of the electronic device according to an embodiment.

Referring to FIG. 2A, the electronic device 100 may include a camera 110, a display 120, a communication interface 130, a memory 140, and at least one processor 150.

The camera 110 may be turned on and capture the image based on a predetermined event. The camera 110 may convert the captured image into an electrical signal and generate image data based on the converted signal. For example, the camera 110 may convert a subject into an electrical image signal via a semiconductor optical device (or a charge-coupled device (CCD)), amplify the image signal converted in this way, convert the same into a digital signal, and then signal-process the digital signal. For example, the camera 110 may be implemented as a general camera, a stereo camera, a depth camera, or the like.

As an example, the camera 110 may be disposed in an outer area of the display 120. For example, the camera 110 may be disposed in the top center, left center, or right center bezel area of the display 120, and is not limited thereto.

The display 120 may be implemented as a display including a self-luminous element, or a display including a non-luminous element and a backlight. For example, the display 120 may be implemented as any of various forms/types of displays, such as a liquid crystal display (LCD), an organic light-emitting diode (OLED) display, a light emitting diode (LED) display, a micro light-emitting diode (micro-LED) display, a mini light-emitting diode (mini-LED) display, a plasma display panel (PDP), a quantum dot (QD) display, a quantum dot light-emitting diode (QLED) display, or the like. The display 120 may also include a driving circuit, a backlight unit and the like, which may be implemented in a form such as a-si thin film transistor (TFT), a low temperature poly silicon (LTPS) TFT, or an organic TFT (OTFT). As an example, the display 120 may be implemented to detect various types of touch inputs by including a touch sensor that detects a touch operation in the form of a touch film, a touch sheet, a touch pad, or the like, which is disposed on a front surface of the display 120. For example, the display 120 may detect the various types of touch inputs, such as touch input by a user hand, touch input by an input device such as a stylus pen, and touch input by a specific electrostatic material. Here, the input device may be implemented as a pen-type input device that may be referred to by various terms such as an electronic pen, the stylus pen, or an S-pen. As an example, the display 120 may be implemented as a flat display, a curved display, a flexible display that may be folded or/and rolled, or the like.

The communication interface 130 may be implemented as any of various interfaces according to an implementation example of the electronic device 100. For example, the communication interface 130 may communicate with an external device, an external storage medium (e.g., USB memory), an external server (e.g., web hard), or the like by using a communication method such as Bluetooth, access point (AP)-based wireless fidelity (Wi-Fi; wireless local area network (LAN) network), Zigbee, wired/wireless LAN, wide area network (WAN), Ethernet, IEEE 1394, high definition multimedia interface (HDMI, universal serial bus (USB), mobile high-definition link (MHL), audio engineering society/European broadcasting union (AES/EBU) communication, optical communication, or coaxial communication. As an example, the communication interface 130 may communicate with the user terminal 200 and/or a remote control device 300.

The memory 140 may store data required for the various embodiments. The memory 140 may be implemented in the form of a memory embedded in the electronic device 100 or in the form of a memory detachable from the electronic device 100, based on a data storage purpose. For example, data for driving the electronic device 100 may be stored in the memory embedded in an electronic device 100′, and data for an extension function of the electronic device 100 may be stored in the memory detachable from the electronic device 100. Meanwhile, the memory embedded in the electronic device 100 may be implemented as at least one of a volatile memory (for example, a dynamic random access memory (DRAM), a static RAM (SRAM), or a synchronous dynamic RAM (SDRAM)) or a non-volatile memory (for example, an one time programmable read only memory (OTPROM), a programmable ROM (PROM), an erasable and programmable ROM (EPROM), an electrically erasable and programmable ROM (EEPROM), a mask ROM, or a flash ROM, a flash memory (for example, a NAND flash or a NOR flash), a hard drive, or a solid state drive (SSD)). In addition, the memory detachable from the electronic device 100′ may be implemented in the form of a memory card (e.g., compact flash (CF), secure digital (SD), micro secure digital (Micro-SD), mini secure digital (Mini-SD), extreme digital (xD), or multi-media card (MMC)), an external memory which may be connected to a universal serial bus (USB) port (for example, a USB memory), or the like.

At least one processor 150 may control overall operations of the electronic device 100. In detail, at least one processor 150 may be connected to each component of the electronic device 100 and control the overall operations of the electronic device 100. For example, at least one processor 150 may be electrically connected to the display 120 and the memory 140 to thus control the overall operations of the electronic device 100. The processor 150 may be one or more processors.

At least one processor 150 may perform the operations of the electronic device 100 according to the various embodiments by executing at least one instruction stored in the memory 140.

At least one processor 150 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor 150 may control one or any combination of other components of the electronic device and perform an operation related to the communication or data processing. At least one processor 150 may execute at least one program or instruction stored in the memory. For example, at least one processor may perform a method according to an embodiment of the present disclosure by executing at least one instruction stored in the memory.

If the method according to an embodiment of the present disclosure includes a plurality of operations, the plurality of operations may be performed by one processor, or may be performed by a plurality of processors. For example, a first operation, a second operation, and a third operation may be performed by the method according to an embodiment. In this case, the first operation, the second operation, and the third operation may all be performed by a first processor. Alternatively, the first operation and the second operation may be performed by the first processor (for example, a general-purpose processor), and the third operation may be performed by a second processor (for example, an artificial intelligence-only processor).

At least one processor 150 may be implemented as a single-core processor including a single core, or may be implemented as at least one multi-core processor including multi-cores (e.g., homogeneous multi-cores or heterogeneous multi-cores). If at least one processor 150 is implemented as the multi-core processor, each of the multi-cores included in the multi-core processor may include a processor internal memory such as a cache memory or an on-chip memory, and a common cache shared by the multi-cores may be included in the multi-core processor. In addition, each (or some) of the multi-cores included in the multi-core processor may independently read and perform a program instruction for implementing the method according to an embodiment of the present disclosure, or all (or some) of the multi-cores may be linked with each other to read and perform the program instruction for implementing the method according to an embodiment of the present disclosure.

If the method according to an embodiment of the present disclosure includes a plurality of operations, the plurality of operations may be performed by one core among the multi-cores included in the multi-core processor, or may be performed by the multi-cores. For example, the first operation, the second operation, and the third operation may be performed using the method according to an embodiment. In this case, the first operation, the second operation, and the third operation may all be performed by a first core included in the multi-core processor. Alternatively, the first operation and the second operation may be performed by the first core included in the multi-core processor, and the third operation may be performed by a second core included in the multi-core processor.

In the embodiments of the present disclosure, the processor may indicate a system-on-chip (SoC) in which at least one processor and other electronic components are integrated with each other, the single-core processor, the multi-core processor, or the core included in the single-core processor or the multi-core processor. Here, the core may be implemented as the CPU, the GPU, the APU, the MIC, the DSP, the NPU, the hardware accelerator, the machine learning accelerator, or the like. However, the embodiments of the present disclosure are not limited thereto. Hereinafter, for convenience of description, at least one processor 150 is referred to as the processor 150.

FIG. 2B is a block diagram showing a specific configuration of an electronic device according to an embodiment.

Referring to FIG. 2B, the electronic device 100′ may include the camera 110, the display 120, the communication interface 130, the memory 140, at least one processor 150, a user interface 160, and a speaker 170. A detailed description of components shown in FIG. 2B that overlap with the components shown in FIG. 2A is omitted.

The user interface 160 may be implemented as a device such as a button, a touch pad, a mouse, or a keyboard, or may be implemented as a touchscreen capable of performing the above-described display function and manipulation input function together.

The speaker 170 may be a component for outputting not only various audio data but also various notification sounds, voice messages, or the like. The processor 150 may control the speaker 170 to output feedback or various notifications in an audio format according to the various embodiments of the present disclosure.

In addition, the electronic device 100′ may include a microphone (not shown), a sensor (not shown), or the like according to an implementation example.

The microphone (not shown) is a component for receiving a user voice or other sounds and converting the same into the audio data. However, according to another embodiment, the electronic device 100′ may receive the user voice input via the external device through the communication interface 130.

The sensor (not shown) may include any of various types of sensors such as a touch sensor, a proximity sensor, an acceleration sensor (or gravity sensor), a magnetometer sensor, a gyro sensor, a pressure sensor, a position sensor, or a distance sensor. For example, the acceleration sensor may be a three-axis acceleration sensor. The three-axis acceleration sensor may measure the acceleration of gravity for each axis and provide raw data to the processor 150. The distance sensor may also be used to detect a distance to the projection surface. The distance sensor may be implemented as any of various types of sensors such as an ultrasonic sensor, an infrared sensor, a light detection and ranging (LIDAR) sensor, a radio detection and ranging (RADAR) sensor, or a photodiode sensor. The geomagnetic sensor or the gyro sensor may be used to acquire posture information, for example, yaw information.

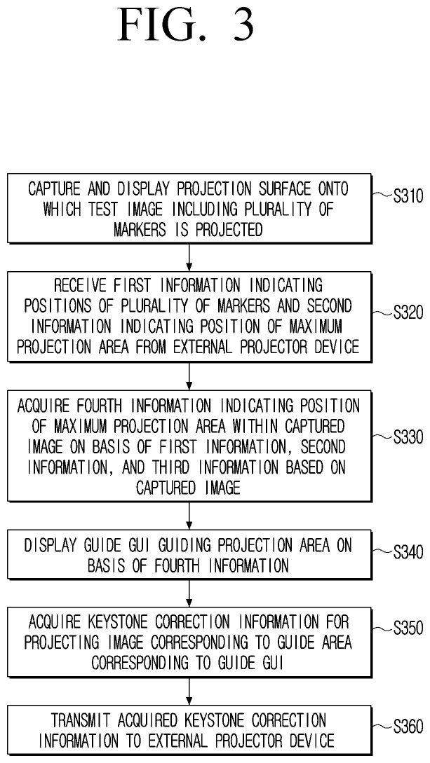

FIG. 3 is a diagram for describing a method for controlling an electronic device according to an embodiment.

According to an embodiment shown in FIG. 3, the processor 150 may control the display 120 to display the captured image acquired by the camera 110 if the camera 110 captures an image including a plurality of markers, for example, the projection surface onto which a test image is projected (S310). For example, the test image may be an image in which a content image includes the plurality of markers. However, although the test image includes another image in addition to the plurality of markers, the test image may include another image (e.g., background image) other than the content image not to overlap with a position where the plurality of markers are included. However, the test image is not limited thereto, and may be an image that includes only the plurality of markers. Here, the marker may be replaced with any of various terms such as a tag, a pattern, or the like.

As an example, the plurality of markers may be implemented as quick response (QR) codes. The plurality of QR codes may represent identities (IDs) of respective positions in different shapes, and are not necessarily limited thereto. For example, the plurality of markers may be a pattern that includes black areas and white areas in a predetermined ratio in each of a plurality of directions. In this case, the marker may include the black areas and the white areas at the predetermined ratio in the plurality of directions, for example, in left-right, up-down, and diagonal directions. For example, a ratio of white pixels to black pixels may be required to be a:a:b:a:a (where, a and b are integers) in any direction of A, B, or C. In this case, the marker may be identified from all 360° directions. For example, the ratio may use any of various values such as 1:1:3:1:1, 1:2:3:2:1 or 1:1:1:4:1:1. That is, the ratio may be modified in any form if the projector device that projects the test image including the marker and a device (e.g., electronic device 100) that identifies a position of the marker in the captured image have a predetermined pattern. As an example, the plurality of markers may be positioned at predefined positions, for example, at positions corresponding to four vertices of the test image in the image, or in an inner area at a critical distance from the four vertices. For example, the plurality of markers may be positioned in the inner area at a predetermined ratio relative to a size of an entire image based on the four vertices of the test image.

The processor 150 may acquire fourth information indicating a position of a maximum projection area within the captured image on the basis of first information, second information, and third information based on the captured image (S330) if the first information indicating the positions of the plurality of markers and the second information indicating a position of a maximum projection area are received from the projector device (S320).

For example, the first information may be information indicating a size of the test image, i.e., current projection screen, if the plurality of markers are disposed in a four-vertex area of the test image. For example, the first information may include coordinate information indicating positions of the four vertices of the test image. In addition, the second information may include coordinate information indicating 41 the four vertices of the maximum projection area. Meanwhile, the third information may be information related to positions of the plurality of markers in the captured image. For example, the third information may be information indicating the size of the test image, i.e., current projection screen, in the captured image if the plurality of markers are disposed in the four-vertex area of the test image. For example, the third information may include coordinate information indicating positions of the four vertices of the test image in the captured image.

As an example, the processor 150 may identify a ratio of the first information to the second information, and apply the identified ratio to the third information to thus acquire the fourth information indicating the position of the maximum projection area within the captured image. For example, the fourth information may include coordinate information of the four-vertex area indicating the position of the maximum projection area.

Hereinafter, for the convenience of description, coordinates in an original image are described as a projector coordinate system, and coordinates in the captured image are described as the camera coordinate system. Accordingly, the first information and the second information may correspond to the projector coordinate system, and the third information and the fourth information may correspond to the camera coordinate system.

The processor 150 may control the display 120 to display a guide graphical user interface (GUI) guiding a projection area on the basis of the fourth information (S340). Here, the guide GUI may be provided in a rectangular line shape having an empty interior, and is not necessarily limited thereto. The guide GUI may be provided in any of various line shapes such as a solid line or a dotted line. In addition, guide GUIs 710 to 760 may be provided in augmented reality (AR) line shapes, or the like. As an example, the guide GUI may be provided to have a predetermined aspect ratio (or ratio), and is not limited thereto. For example, the guide GUI may be provided to have an aspect ratio corresponding to aspect ratio information of the projection image, and the aspect ratio information of the projection image may be acquired from an external projection device or predicted by the processor 150 based on the captured image. For example, the aspect ratio of the guide GUI may include any of various aspect ratios such as 16:9, 21:9, or 4:3. In addition, the guide GUI may be provided in a form in which the user may modify at least one of its size or position through manipulation (e.g., touch drag input). However, the guide GUI is not limited thereto, and the user may drag the guide GUI to a desired position and a desired size.

As an example, the guide GUI may correspond to corrected coordinates that maintain the center of the current projection screen without deviating the maximum projection area based on the fourth information. That is, the processor 150 may calculate the corrected coordinates of the current projection screen (hereinafter, also referred to as fifth information) from the captured image on the basis of the fourth information, and display the guide GUI on the basis of the corrected coordinates (fifth information). For example, the processor 150 may calculate the corrected coordinates (fifth information) on the basis of environmental information included in the captured image. For example, the processor 150 may calculate the corrected coordinates (fifth information) to make the corrected coordinates perpendicular to a direction of gravity, that is, to align a vertical direction of the guide GUI with the direction of gravity if the captured image captures a wall (for example, if a direction of gravity acceleration is within 3 degrees of a bottom direction of the captured image). Accordingly, an error occurring due to a slight tilt of the electronic device 100 during capturing the image may be prevented. Alternatively, the processor 150 may calculate the corrected coordinates (fifth information) to make the captured image a rectangle parallel to an angle of the captured image if the captured image is a photograph capturing the ceiling or captured using intentional rotational manipulation (for example, if the direction of gravity acceleration differs by 3 degrees or more from the bottom direction of the captured image).

Next, the processor 150 may acquire keystone correction information for projecting an image corresponding to a guide area corresponding to the guide GUI (S350). For example, the processor 150 may calculate the corrected coordinates of the projection screen (hereinafter, also referred to as sixth information) by applying a ratio of the fourth information to the fifth information to the second information.

The processor 150 may then transmit the acquired keystone correction information to the projector device (S360). For example, the processor 150 may transmit the corrected coordinates of the projection screen (the sixth information) to the projector device. In this case, the projector device may output the image based on the first information, that is, project the image being projected by applying a perspective transformation based on the sixth information.

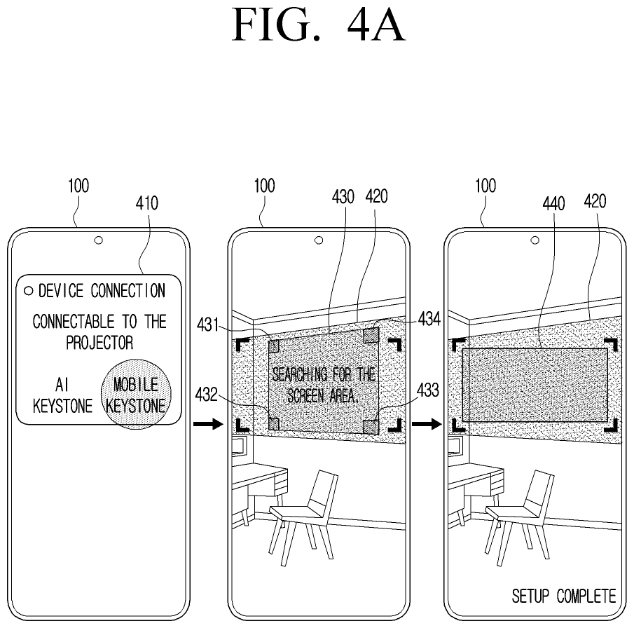

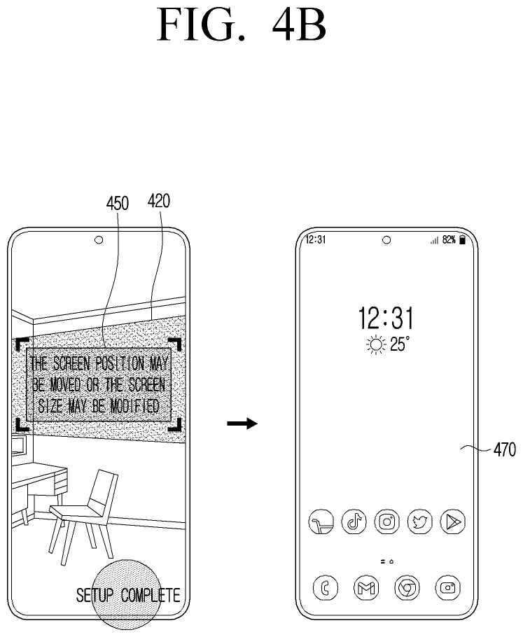

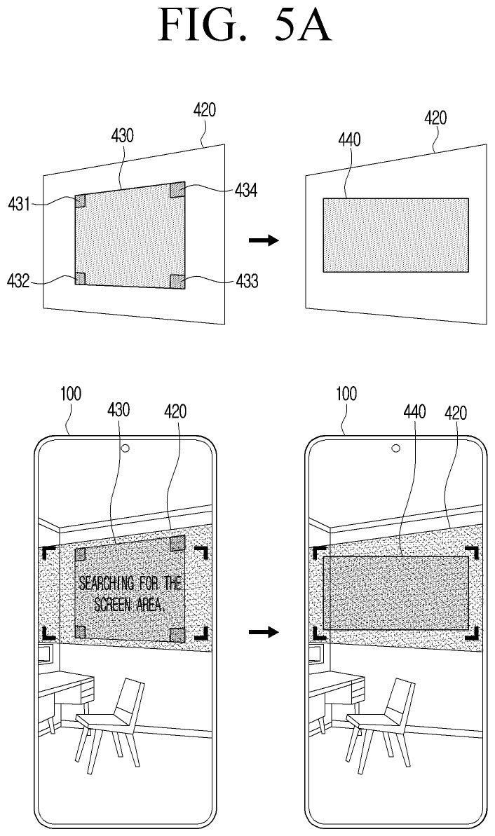

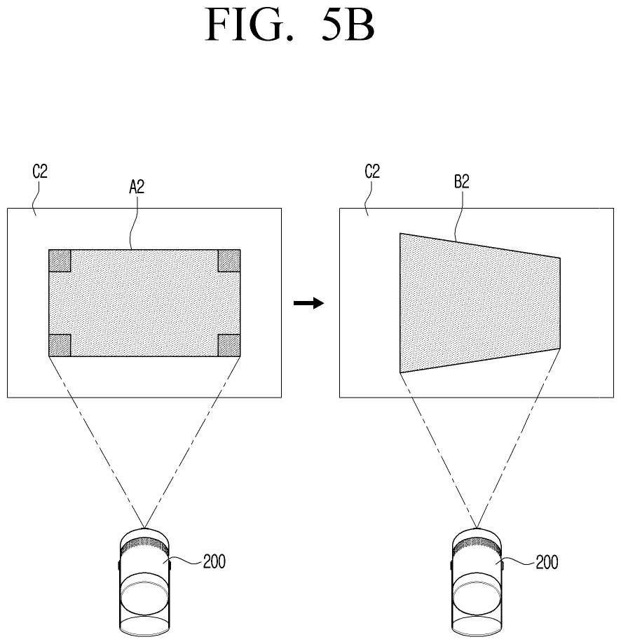

FIGS. 4A, 4B, 5A, and 5B are diagrams for describing a method for acquiring the keystone correction information according to an embodiment.

According to an example shown in FIG. 4A, the processor 150 may provide a UI 410 for connection to the projector based on the predetermined event, and execute an auto keystone function based on a user command. For example, the processor 150 may provide a UI including a maximum projection area 420 and a current projection area 430 if the projection surface is captured using the camera 110. In detail, the processor 150 may calculate the corrected coordinates that maintain the center of the current projection screen within the maximum projection area 420 and maintain the predetermined ratio (e.g., 16:9), and provide an area 440 corresponding to the corrected coordinates through a guide GUI.

A left side of FIG. 5A shows the captured image, that is, third information A1 related to a plurality of markers 431, 432, 433, and 434 in the camera coordinate system and fourth information C1 corresponding to the maximum projection area, and a right side of FIG. 5A shows the captured image, that is, fifth information B1 corresponding to the corrected coordinates of the current projection screen in the camera coordinate system.

A left side of FIG. 5B shows first information A2 related to the plurality of markers in the original test image, that is, the projector coordinate system, and second information C2 corresponding to the maximum projection area, and a right side of FIG. 5B shows sixth information B2 corresponding to the corrected coordinates of the current projection screen in the projector coordinate system. The processor 150 may calculate the sixth information B2 by applying a ratio of the fourth information C1 to the fifth information B1 to the second information C2.

Meanwhile, as shown in FIG. 4B, the processor 150 may provide a UI 450 guiding “The screen position may be moved or modified”, and a menu button 460 for selecting an end of an auto keystone operation if the auto keystone operation is completed. Next, the processor 150 may end an auto keystone execution screen if the menu button 460 is selected.

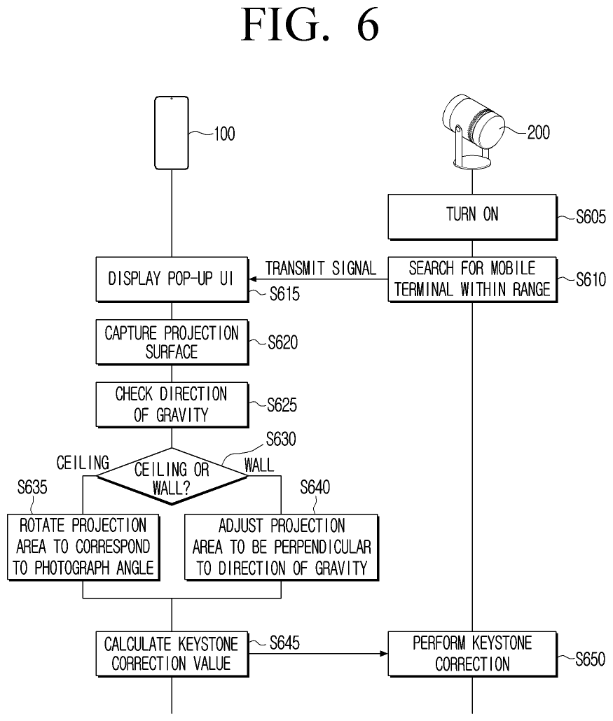

FIG. 6 is a diagram for describing one scenario of a method for providing the auto keystone according to an embodiment.

According to an embodiment shown in FIG. 6, a projector device 200 may search a mobile terminal within predetermined range (e.g., range where short-range communication is possible) (S610) if the projector device 200 is turned on (S605). For example, the projector device 200 may scan a peripheral device via Bluetooth communication, and transmit a connection notification signal (e.g., Bluetooth low energy (BLE) signal) to the electronic device 100 if the electronic device 100 is scanned.

The electronic device 100 may display a pop-up UI for executing the auto keystone function if the connection notification signal is received from the projector device 200 (S615). For example, the electronic device 100 may display the pop-up UI 410 shown in FIG. 4A.

The electronic device 100 may turn on the camera 110 and start capturing the projection surface if the auto keystone function is executed through the pop-up UI (S620).

As an example, the electronic device 100 may identify the environmental information of the projection surface, for example, whether the projection surface is the ceiling or the wall (S630), by checking the direction of gravity on the basis of data acquired through the sensor (S625). The electronic device 100 may adjust the projection area by rotating the projection area to correspond to a photograph angle if the projection surface is identified as the ceiling (S635). The electronic device 100 may adjust the projection area to be perpendicular to the direction of gravity if the projection surface is identified as the wall (S640).

The electronic device 100 may calculate a keystone correction value on the basis of the adjusted projection area (S645) and transmit the calculated keystone correction value to the projector device 200.

The projector device 200 may perform the keystone correction on the basis of the keystone correction value received from the electronic device 100 (S650).

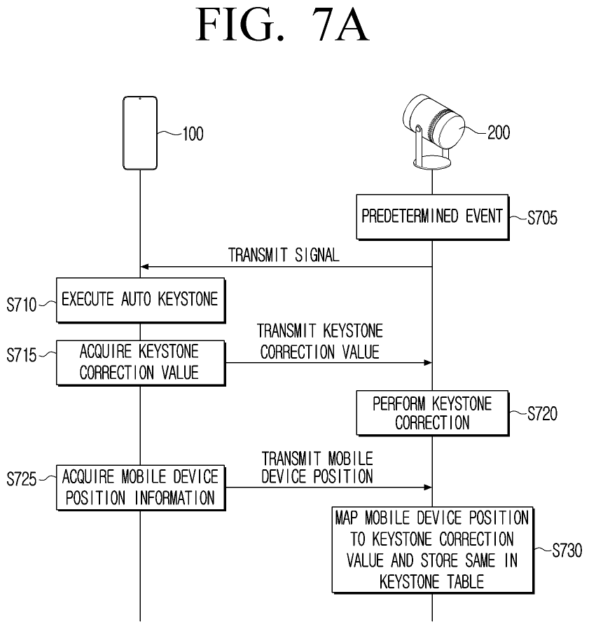

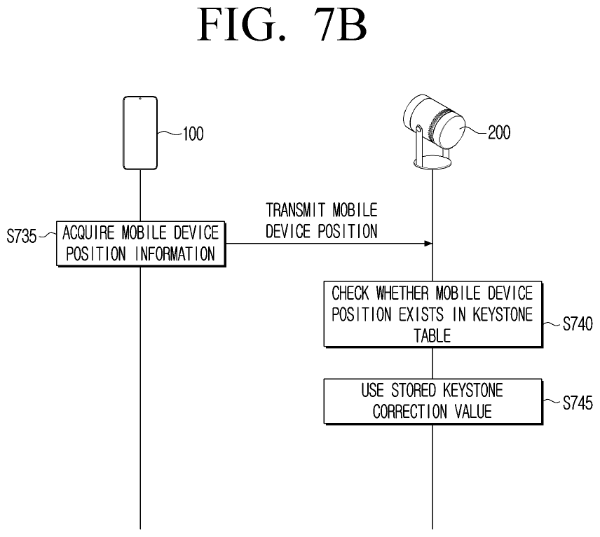

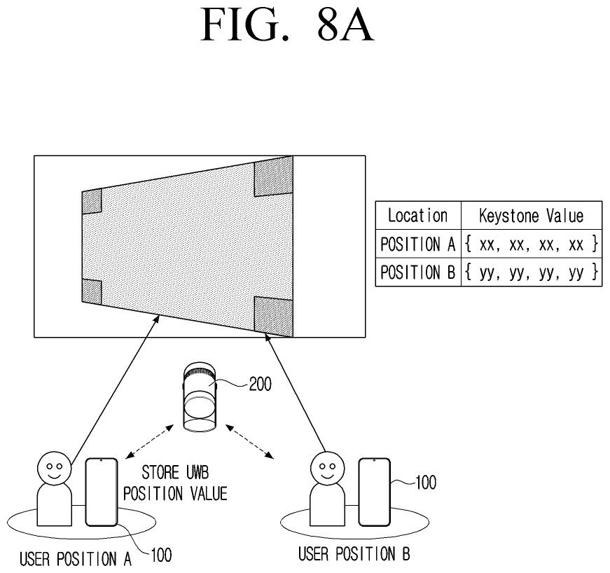

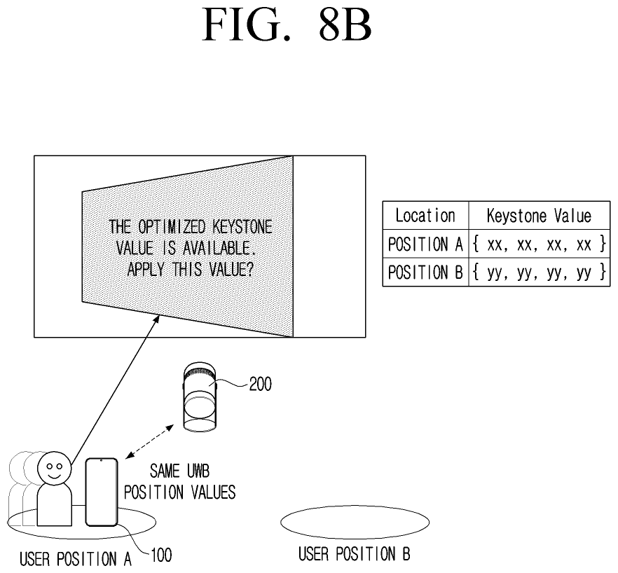

FIGS. 7A, 7B, 8A, and 8B are diagrams for describing a method for providing the keystone correction information according to an example.

According to an embodiment, the electronic device 100 may transmit spatial information (or position information) from which the keystone correction information is acquired to the projector device 200 together with the keystone correction information, thus enabling the projector device 200 to use the keystone correction information later. Here, the spatial information may include information on a distance between the electronic device 100 and the projector device 200 and information on a direction of the electronic device 100 relative to the projector device 200.

According to an example shown in FIG. 7A, the projector device 200 may transmit a corresponding signal to the electronic device 100 if the predetermined event occurs in the projector device 200 (S705). Here, the predetermined event may be the same event as the event in step S605 or S610 in FIG. 6, and is not necessarily limited thereto. For example, various events may occur that may cause the auto keystone function to be executed by the electronic device 100, such as the user command or a position movement of the projector device 200.

The electronic device 100 may execute the auto keystone function on the basis of the signal received from the projector device 200 (S710), acquire the keystone correction value, and transmit the acquired keystone correction value to the projector device 200 (S715).

The projector device 200 may perform the keystone correction on the basis of the received keystone correction value (S720). The electronic device 100 may acquire position information of the electronic device 100 (i.e., user position information) and transmit the acquired information to the projector device 200 (S725). However, the position information of the electronic device 100 may be transmitted to the projector device 200 together with the keystone correction value at step S715. Here, the position information of the electronic device 100 may include the information on the distance between the electronic device 100 and the projector device 200 and the information on the direction of the electronic device 100 relative to the projector device 200.

The projector device 200 may map the position information of the electronic device 100 to the keystone correction value corresponding to the corresponding position and store the same in a keystone table (S730).

According to an example shown in FIG. 7B, the electronic device 100 may acquire the position information of the electronic device 100 based on the predetermined event and transmit the acquired information to the projector device 200 (S735). Here, the predetermined event may include various events for performing the keystone correction on the basis of the keystone correction value pre-stored in the projector device 200, such as the user command or the signal reception from the projector device 200.

The projector device 200 may check whether the received position information of the electronic device 100 exists in the keystone table (S740). The projector device 200 may perform the keystone correction by using the keystone correction value mapped to the position information if the received position information of the electronic device 100 exists in the keystone table (S745).

For example, as shown in FIG. 8A, a plurality of user positions A and B (for example, a dining table or a table in front of a sofa) may exist where the user mainly views the image if the projector device 200 is implemented as a fixed projector, or if the user uses a movable projector by fixing the same to a predetermined position. In this case, the electronic device 100 may identify a relative position between the electronic device 100 and the projector device 100 (i.e., relative position between the user and the projector device 100) if the auto keystone function is executed for the first time at each of the corresponding positions, that is, the user position A and the user position B, and may map and store the position information and the keystone correction value corresponding to the corresponding position in the keystone table. For example, the electronic device 100 may acquire the user position information by using ultra wide band (UWB) technology, is not limited thereto, and may use various indoor positioning technologies. Here, the user position information may include the distance information and the direction information between the user and the projector device 100. As an example, the electronic device 100 may transmit the user position information and the keystone correction value to the projector device 200, and the projector device 200 may map and store the corresponding information in the keystone table.

As shown in FIG. 8B, the projector device 200 may then automatically apply the keystone correction value on the basis of the information stored in the keystone table if the user re-views the image at the user position A. As an example, the projector device 200 may automatically perform the keystone correction by identifying the keystone correction value mapped to the corresponding position information from the pre-stored keystone table if the projector device 200 receives the position information corresponding to the user position A from the electronic device 100. In this case, as shown in FIG. 8B, the projector device 200 may also provide a pop-up UI asking whether to perform correction based on the pre-stored keystone correction value, and then perform the keystone correction. As another example, the electronic device 100 may identify the keystone correction value mapped to the corresponding position information from the pre-stored keystone table and transmit the identified keystone correction value to the projector device 200 if a current position of the electronic device 100 is identified as corresponding to the user position A. In this case, the electronic device 100 may also provide the pop-up UI asking whether to perform the correction according to the pre-stored keystone correction value and then transmit the keystone correction value to the projector device 200.

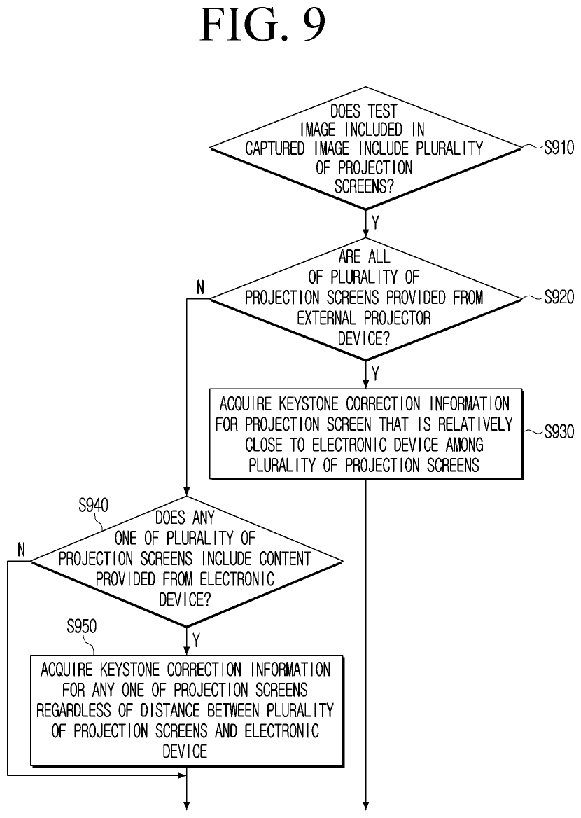

FIGS. 9, 10, 11A, 11B, 12A, and 12B are diagrams for describing a keystone correction method for the plurality of projection screens according to an embodiment.

According to an embodiment, the plurality of screens may be required to be projected separately if a plurality of users view the projection screen. For example, the projector device 200 may project a plurality of content received from a plurality of sources to separate screens, or may project content received from the same source to the separate screens.

According to an embodiment shown in FIG. 9, the processor 150 may identify whether all of the content included in the plurality of projection screens is provided from an external source device (S920) if the test image included in the captured image includes the plurality of projection screens (S910-Y). Here, the external source device may indicate a device other than the electronic device 100. Here, the plurality of projection screens may respectively provide a plurality of first content provided from a plurality of sources or a plurality of second content provided from a single source.

The processor 150 may acquire the keystone correction information by performing the keystone correction on the projection screen that is relatively close to the electronic device 100 among the plurality of projection screens (S930) if all of the content included in the plurality of projection screens is identified as being provided from the external source device (S920-Y).

Meanwhile, the processor 150 may acquire the keystone correction information by performing the keystone correction on the corresponding projection screen regardless of a distance between the plurality of projection screens and the electronic device 100 (S950) if any one of the plurality of projection screens is identified as including the content provided from the electronic device 100 (S940-Y). The reason is that a viewer of the projection screen including the content provided from the electronic device 100 may be considered as the user of the electronic device 100.

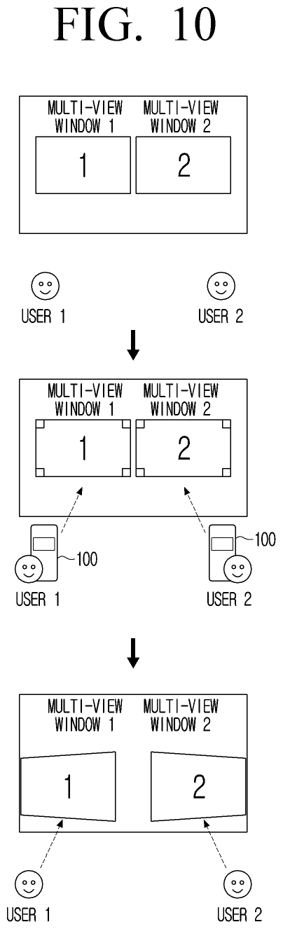

As an example, as shown in FIG. 10, the electronic device 100 may perform the keystone correction for providing the projection screen suitable for a field of view of each user if the plurality of users (e.g., user 1 and user 2) view a multi-view screen including content received from different sources. In this case, the plurality of markers (e.g., QR codes) may be provided to each of a multi-view window 1 and a multi-view window 2 to perform the keystone correction in the electronic device 100 provided to each of the users. In this case, the electronic device 100 of each user may perform the keystone correction by capturing a window that is closer among the multi-view window 1 and the multi-view window 2. Accordingly, the electronic device 100 may provide each user with a separate projection screen having a suitable viewing angle.

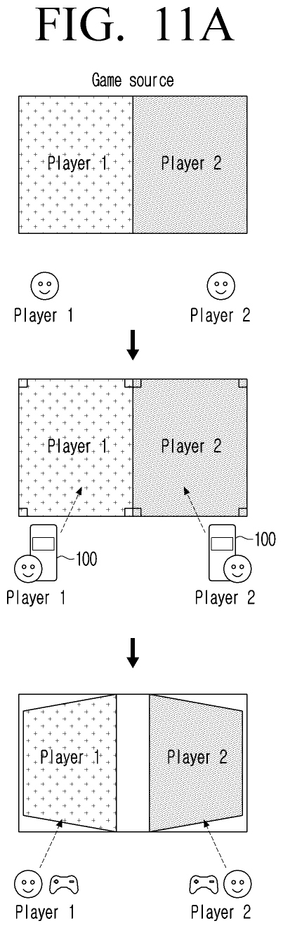

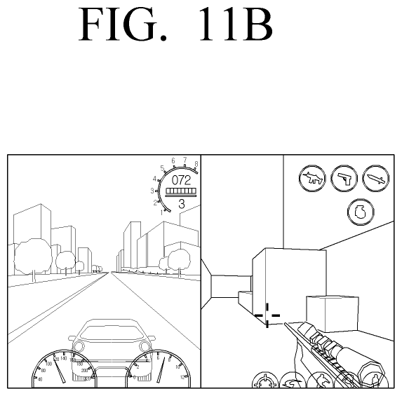

As an example, as shown in FIG. 11A, the electronic device 100 may perform the auto keystone correction for providing the projection screen suitable for the field of view of each user if the plurality of users (e.g., user 1 and user 2) view a multi-view screen including content received from the same source. In this case, as shown in FIG. 11A, the plurality of markers (e.g., QR codes) may be provided to each of a screen of Player 1 and a screen of Player 2 to perform the keystone correction in the electronic device 100 provided to each of the users. For example, as shown in FIG. 11B, the projector device 200 may analyze the projected image to identify a split screen and provide the plurality of markers to each screen if a multiplayer game screen is provided from the same game source. However, the electronic device 100 may also analyze the captured image to identify the split screen, and request the projector device 200 to provide the plurality of markers to each screen. For example, the electronic device 100 and/or the projector device 200 may analyze the projected image by using an artificial intelligence model to identify the split screen. In this case, the electronic device 100 of each user may perform the keystone correction by capturing a screen that is closer among the screen of Player 1 and the screen of Player 2. Accordingly, the electronic device 100 may provide each user with the split projection screen having the suitable viewing angle.

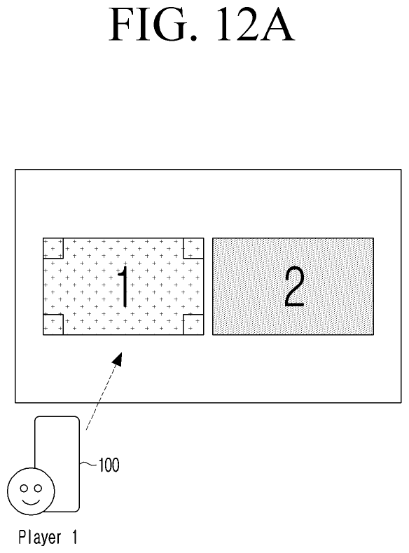

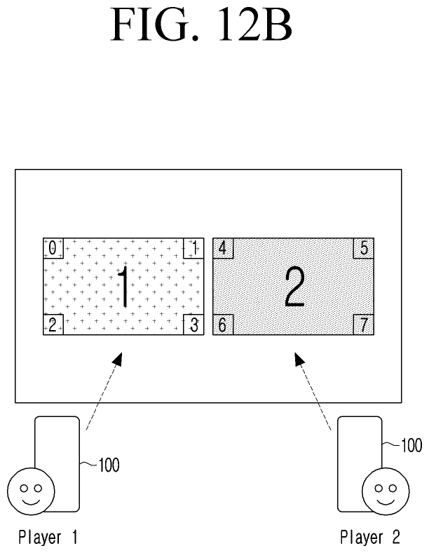

As an example, as shown in FIG. 12A, the processor 150 may identify the user position on the basis of the captured image, and allow the plurality of markers for the keystone correction to be provided to a screen corresponding to the user position (or direction) among the plurality of screens. For example, as shown in FIG. 12A, the processor 150 may request the projector device 200 to provide the plurality of markers for the keystone correction to a left screen among the plurality of screens if the user (e.g., Player 1) is identified as positioned on a left side of the projection screen. In addition, as shown in FIG. 12b, the processor 150 may allow the plurality of markers for the keystone correction to be provided to each of the plurality of screens if the keystone correction is performed in each of the electronic devices 100 of the plurality of users (e.g., Player 1 and Player 2).

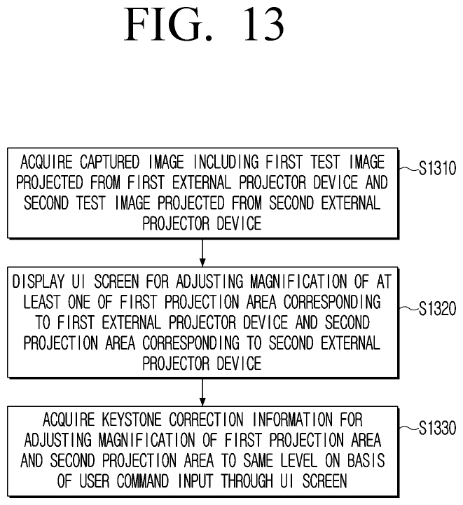

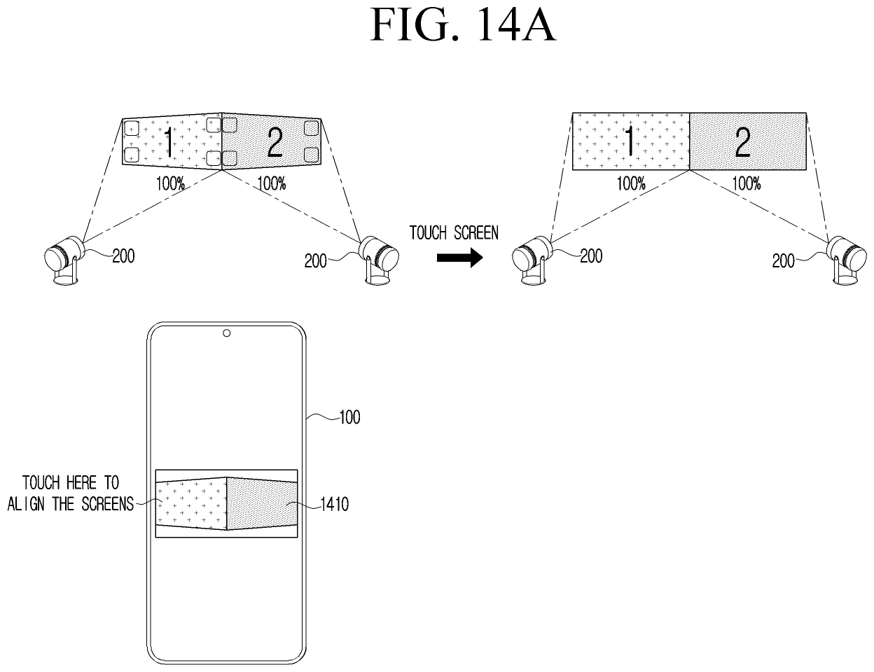

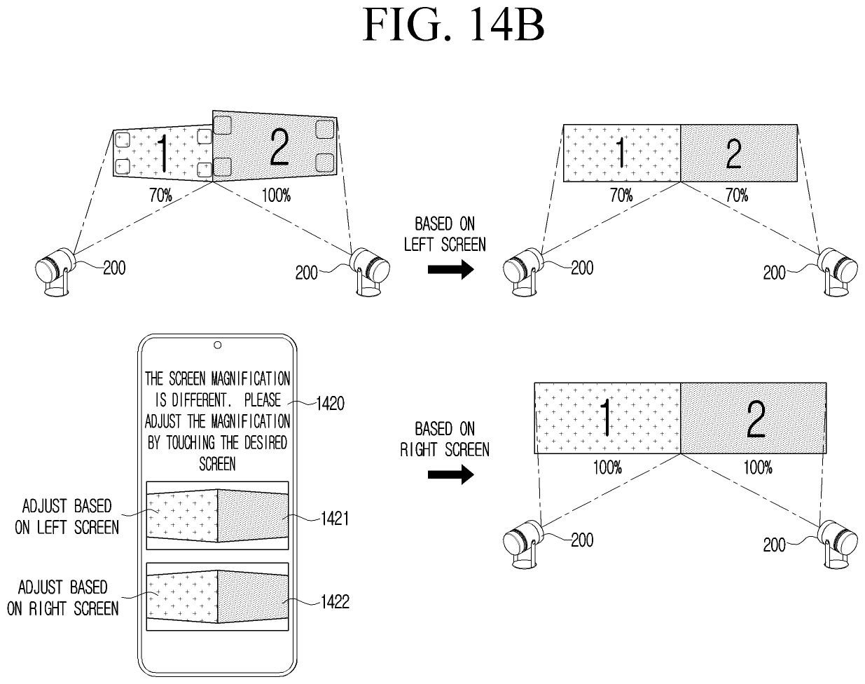

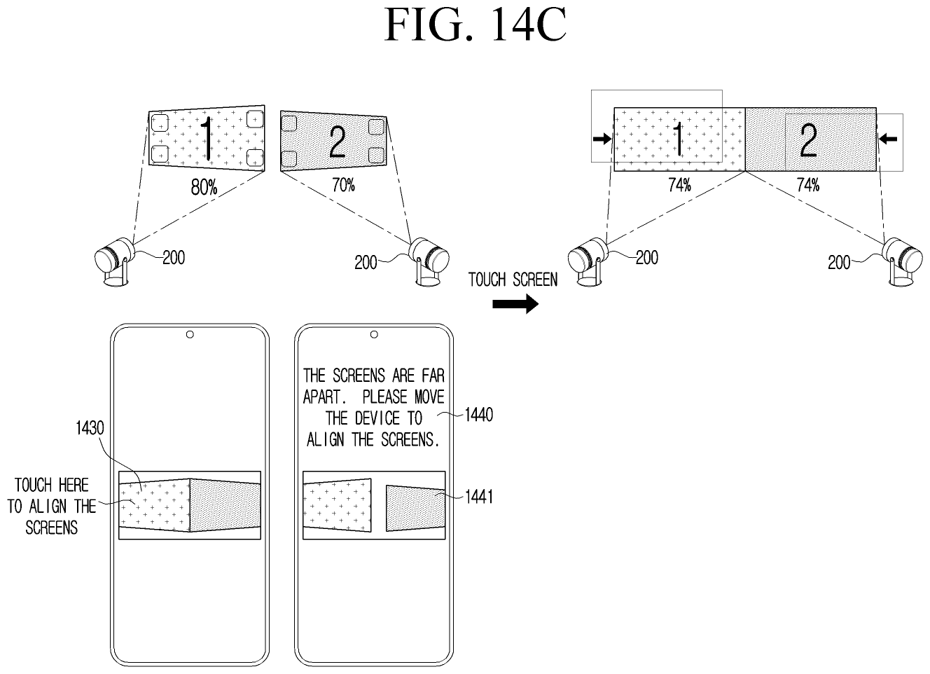

FIGS. 13, 14A, 14B, and 14C are diagrams for describing the keystone correction method in case of using the plurality of projector devices according to an embodiment.

According to an embodiment, the plurality of projector devices 200 may project the projection screens to the respective projection surfaces. In this case, the processor 150 may acquire the keystone correction information for adjusting magnification of the plurality of projection screens to the same level based on the user command by providing a UI for maintaining or adjusting the magnification of at least one of the plurality of projection screens.

According to an embodiment shown in FIG. 13, the processor 150 may acquire the captured image including a first test image projected from a first projector device and a second test image projected from a second projector device (S1310).

The processor 150 may control the display 120 to display a UI screen for adjusting the magnification of at least one of a first projection area corresponding to the first projector device and a second projection area corresponding to the second projector device (S1320).

The processor 150 may then acquire the keystone correction information for adjusting the magnification of the first projection area and the second projection area to the same level on the basis of the user command input through the UI screen (S1330).

As an example, as shown in FIG. 14A, the processor 150 may provide a UI 1410 for performing the keystone correction while maintaining the magnification, and acquire the keystone correction information for each projection screen while maintaining the magnification of the projection screen based on the user command if the magnification of the respective projection screens projected by the plurality of projector devices 200 is the same (for example, 100%). For example, the processor 150 may acquire the keystone correction information for each projection screen while maintaining the magnification of the projection screen if the UI 1410 including guidance message such as “Touch here to align the screens” and an icon corresponding to each projection screen is provided and the UI 1410 is selected. The processor 150 may then transmit the keystone correction information for each projection screen to the corresponding projector device 200.

As an example, as shown in FIG. 14B, the processor 150 may provide a UI 1420 for the user to select desired magnification and acquire the keystone correction information for each projection screen on the basis of the selected magnification based on the user command if the magnification of the respective projection screens projected by the plurality of projector devices 200 is different (for example, 70% and 100%). For example, the processor 150 may provide guidance message such as “The screen magnification is different. Please adjust the magnification by touching the desired screen” and UIs 1421 and 1422 for the user to select the desired magnification reference. For example, the processor 150 may acquire the keystone correction information for each projection screen while maintaining the magnification (70%) of the left screen and adjusting the magnification of a right screen to 70% to be the same as the left screen if the UI 1421 corresponding to “Adjust based on the left screen” is selected. For example, the processor 150 may acquire the keystone correction information for each projection screen while maintaining the magnification (100%) of the right screen and adjusting the magnification of the left screen to 100% to be the same as the right screen if the UI 1422 corresponding to “Adjust based on the right screen” is selected. The processor 150 may then transmit the keystone correction information for each projection screen to the corresponding projector device 200.

As an example, as shown in FIG. 14C, the processor 150 may acquire the keystone correction information for each projection screen to adjust the projection screens to maximum magnification by moving the projection screens to be adjacent to each other if at least one projection screen has magnification less than 100% and both the projection screens are capable of being moved to overlap with (or be adjacent to) each other even though the respective projection screens projected by the plurality of projector devices 200 are spaced apart from each other. In this case, the processor 150 may provide a UI 1430 including guidance message such as “Touch here to align the screens” and an icon corresponding to each projection screen after the projection screens are moved, and may adjust the projection screens to the maximum magnification by moving the projection screens to be adjacent to each other based on the user command. However, the processor 150 may guide the user to move the position of the projector device 200 by providing a UI 1440 including a guidance message (or warning message) such as “The screens are far apart. Please move the device to align the screens.” and an icon UI 1441 indicating a state of the current projection screen if the projection screens are unable to be moved to be adjacent to each other.

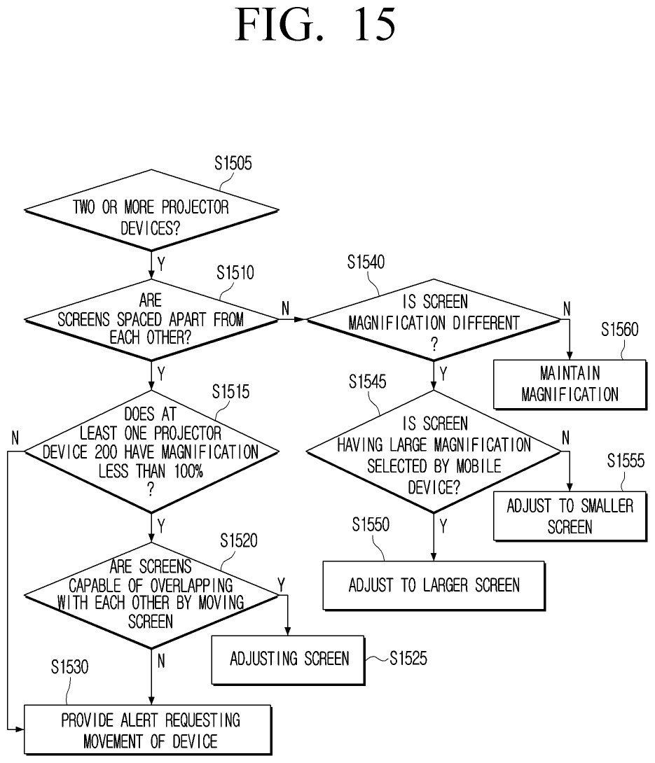

FIG. 15 is a diagram for describing a scenario in case of using the plurality of projector devices according to an embodiment.

According to an example shown in FIG. 15, the electronic device 100 may identify whether the plurality of projection screens are spaced apart from each other (S1510) if two or more projector devices 200 are identified as projecting the images (S1505-Y).

The electronic device 100 may identify whether at least one projector device 200 has the magnification less than 100% (S1515) if the plurality of projection screens are identified as being spaced apart from each other (S1510-Y).

The electronic device 100 may identify whether the plurality of projection screens are capable of overlapping with (or being adjacent to) each other by moving at least one projection screen (S1520) if at least one projector device 200 is identified as having the magnification of less than 100% (S1515-Y).

The electronic device 100 may acquire the keystone correction value by adjusting the plurality of projection screens to overlap with each other (S1525) if the plurality of projection screens are identified as being capable of overlapping with each other (S1520-Y).

The electronic device 100 may provide an alert (e.g., UI 1440 or 1450 in FIG. 14C) requesting the movement of the projector device 200 (S1530) if the plurality of projection screens are identified as being incapable of overlapping with each other (S1520-N).

Meanwhile, the electronic device 100 may identify whether the magnification of the plurality of projection screens is different (S1540) if the plurality of projection screens are identified as not being spaced apart from each other in step S1510 (S1510-N).

The electronic device 100 may perform the keystone correction while adjusting magnification of the remaining projection screens to magnification of the selected projection screen (S1550) if the magnification of the plurality of projection screens is identified as being different (S1540-Y) and if the projection screen having large magnification is selected by the electronic device 100 (i.e., mobile device) (S1545-Y). The electronic device 100 may perform the keystone correction while adjusting the magnification of the remaining projection screens to the magnification of the selected projection screen (S1555) if the projection screen having smaller magnification is selected by the electronic device 100 (i.e., mobile device) (S1545-N).

Meanwhile, the electronic device 100 may perform the keystone correction while maintaining the magnification of the plurality of projection screens (S1560) if the magnification of the plurality of projection screens is identified as being the same at step S1540 (S1540-N).

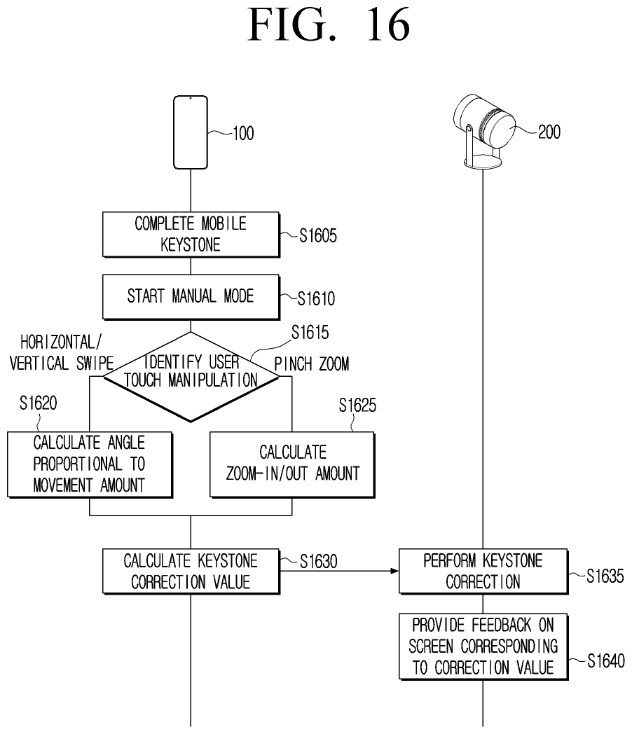

FIGS. 16, 17, 18A, and 18B are diagrams for describing a method for adjusting the projection screen using user interaction according to an embodiment.

According to an embodiment, the electronic device 100 may display a first guide GUI guiding the current projection area and a second guide GUI guiding the maximum projection area. The electronic device 100 may provide feedback on an adjustable area of the first guide GUI on the basis of the second guide GUI if at least one of the size, position, or direction of the first guide GUI is adjusted based on the user command. Here, the feedback may include at least one of visual feedback, sound feedback, or haptic feedback.

According to a scenario shown in FIG. 16, the electronic device 100 may provide a manual mode in which the user may adjust the projection area (S1610) if the above-described mobile keystone (or auto keystone) correction operation is completed (S1605). In the manual mode, the guide GUI may be implemented to enable the user to adjust at least one of the size, position, or direction by the touch input on a live-view screen of the captured image.

The electronic device 100 may calculate the keystone correction value (S1630) by calculating an angle proportional to a movement amount (S1620) if a user touch manipulation is a predetermined first manipulation (S1615), for example, a horizontal/vertical swipe manipulation. In addition, the electronic device 100 may calculate a zoom-in/out amount (S1625) if the user touch manipulation is a predetermined second manipulation, for example, a pinch zoom manipulation, and transmit the calculated keystone correction value to the projector device 200 (S1630).

The projector device 200 may perform the keystone correction on the basis of the received keystone correction value (S1635) and provide feedback on the projection screen corresponding to the keystone correction (S1640). For example, the projector device 200 may provide the projection screen displaying a feedback message indicating that the keystone correction is performed on the projection screen based on a specific user manipulation.

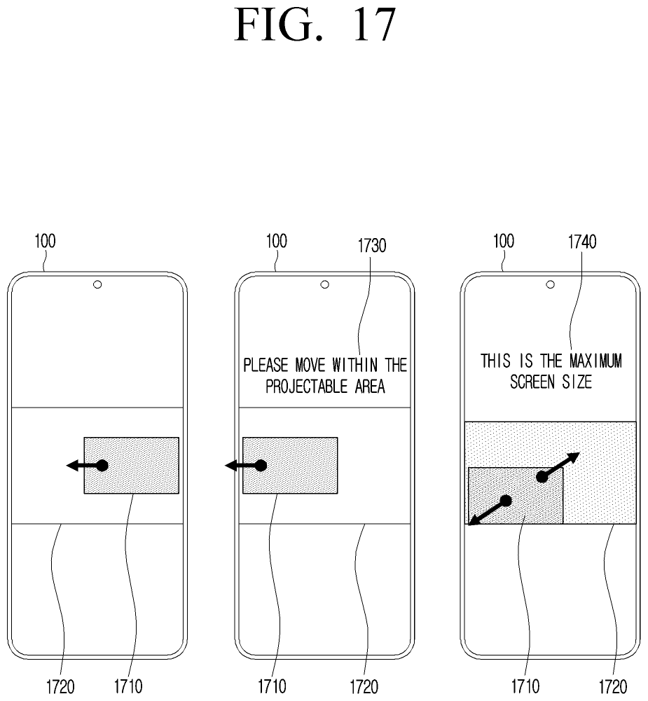

For example, as shown in FIG. 17, the electronic device 100 may provide a first guide GUI 1710 guiding the current projection area and a second guide GUI 1720 guiding the maximum projection area, i.e., a boundary guide for a movable area. For example, the user may move a position of the projection area through a long tap & drag manipulation, and adjust a size of the projection area through a pinch zoom in/out manipulation. In this case, the electronic device 100 may provide information related to the tapped position. For example, the electronic device 100 may display the tapped position as an indicator, or provide a guide message 1730 such as “Please move within the projectable area” or a guide message 1740 such as “This is the maximum screen size.” In addition, the electronic device 100 may provide not only the visual feedback, but also the sound feedback, the haptic feedback, or the like if the adjusted first guide GUI 1710 deviates from a second guide GUI 1720 or if the adjusted first guide GUI 1710 becomes the same as the second guide GUI 1720.

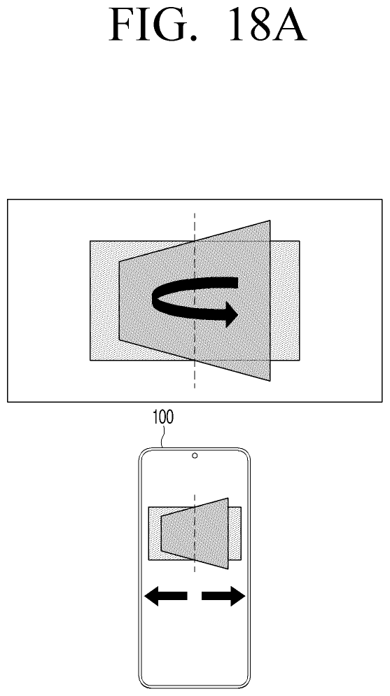

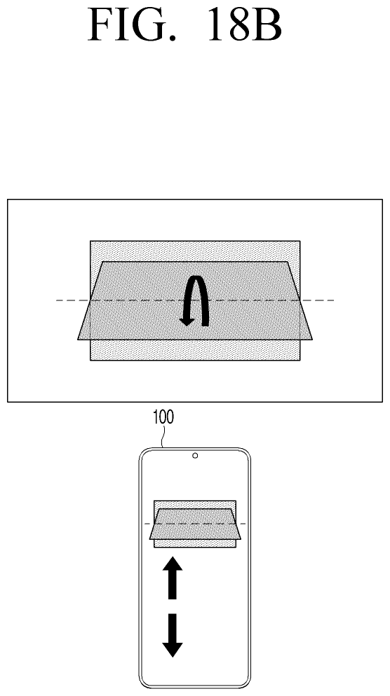

For example, as shown in FIGS. 18A and 18B, the electronic device 100 may provide a UI screen for rotating an angle of the projection screen. For example, the electronic device 100 may acquire the keystone correction value by converting a touch drag range along the X-axis/Y-axis on the UI screen into an X-axis/Y-axis rotation range of the projection screen. For example, as shown in FIG. 18A, the electronic device 100 may acquire the keystone correction value for a Y-axis rotation of the projection screen on the basis of a left/right movement value in the X-axis direction on the UI screen. In addition, as shown in FIG. 18B, the electronic device 100 may acquire the keystone correction value for an X-axis rotation of the projection screen on the basis of a Y-axis up/down movement value on the UI screen. As an example, a rotation angle of the projection screen may also be provided through the UI screen.

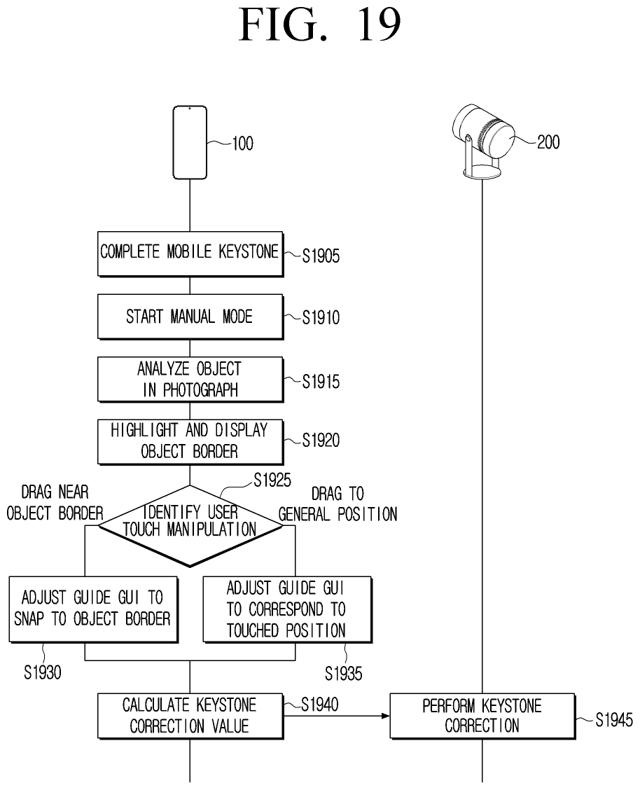

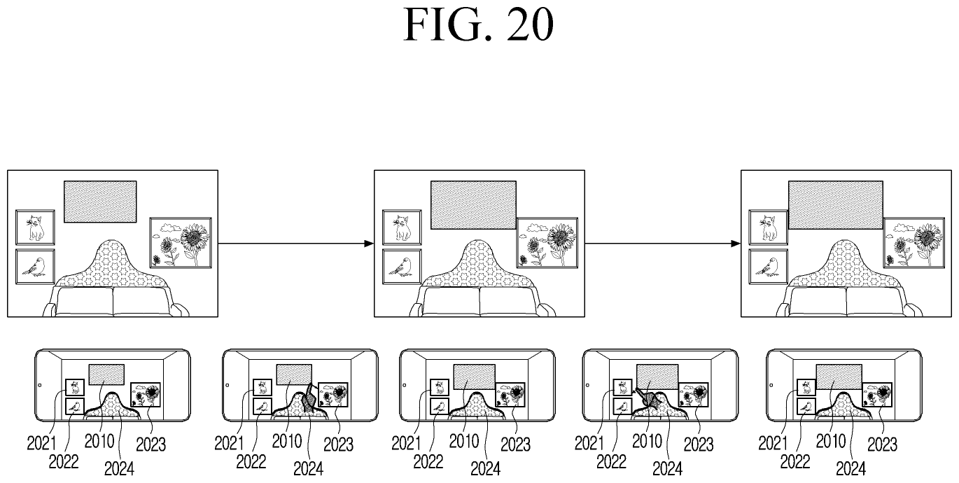

FIGS. 19 and 20 are diagrams for describing a method for adjusting the projection screen based on a surrounding environment according to an embodiment.

According to an embodiment, the electronic device 100 may identify the position of the object included in the captured image, and automatically adjust and display the adjusted guide GUI on the basis of the position of the identified object if at least one of the size or position of the guide GUI is manually adjusted by a user input.

According to a scenario shown in FIG. 19, the electronic device 100 may provide the manual mode in which the user may adjust the projection area (S1910) if the above-described mobile keystone (or auto keystone) correction operation is completed (S1905).

The electronic device 100 may identify the object included in the captured image (S1915) and provide a UI screen including an image in which an object border is highlighted and displayed (S1920).

The electronic device 100 may identify whether the user touch manipulation on the guide GUI corresponding to the projection screen is a drag manipulation near the object border or a drag manipulation to a general position (S1925). Here, the general position may be a position spaced apart from the object by a predetermined distance or more.

The electronic device 100 may adjust the guide GUI to snap to the object border (S1930) if the user touch manipulation for the guide GUI is identified as the drag manipulation near the object border.

The electronic device 100 may adjust the guide GUI to correspond to a touched position if the user touch manipulation on the guide GUI is identified as the drag manipulation to the general position (S1935).

The electronic device 100 may then calculate the keystone correction value on the basis of the adjusted guide GUI and transmit the calculated keystone correction value to the projector device 200 if the guide GUI is completely adjusted (S1940). The projector device 200 may perform the keystone correction on the basis of the received keystone correction value (S1945). In some cases, the projector device 200 may provide feedback on the projection screen corresponding to the keystone correction (S1945). For example, the projector device 200 may provide the projection screen including a feedback message indicating that the keystone correction is performed on the projection screen by avoiding an obstacle.

For example, as shown in FIG. 20, the electronic device 100 may provide a guide GUI 2010 guiding the projection screen and a UI screen highlighting and displaying edges of objects 2021, 2022, 2023, and 2024 recognized in the captured image. In this case, the edges of the objects 2021, 2022, 2023, and 2024 may all be highlighted and displayed or only the edges disposed toward the guide GUI 2010 may be highlighted and displayed.

The guide GUI 2010 may be automatically adjusted to a maximum projection screen size based on the object 2023 by snapping near the edge of the object 2023 if a user drag input to the guide GUI 2010 on the UI screen is identified toward the object 2023.

In addition, the guide GUI 2010 may be moved to a range where the guide GUI 2010 does not collide after being snapped if the guide GUI 2010 is zoomed out to the snapped target object 2021 and collides with another object 2024. Here, the guide GUI 2010 may have a reduced size while maintaining its snapped position if the guide GUI 2010 collides with yet another object.

Meanwhile, although not shown in the drawings, according to an embodiment, the plurality of users may view one projection screen at positions spaced apart from each other. In this case, the plurality of users may each acquire the keystone correction values at the positions of the electronic devices 100 owned by the respective users, that is, at the respective positions of the plurality of users, and then perform the keystone correction by using a representative value of the acquired keystone correction values. For example, any one of the plurality of electronic devices owned by the users (e.g., master device) may receive the keystone correction value from another electronic device, average the received value and the keystone correction value of the master device, acquire a final keystone correction value, and transmit the acquired final keystone correction value to the projector device 200. Alternatively, only the electronic device having the highest priority among the plurality of electronic devices may transmit the keystone correction value to the projector device 200 if the keystone correction is performed at the respective positions of the plurality of electronic devices. Alternatively, all of the plurality of electronic devices may also transmit the keystone correction values to the projector device 200, and the projector device 200 may perform the keystone correction by using the keystone correction value received from the electronic device having the highest priority if the keystone correction is performed at the respective positions of the plurality of electronic devices.

In addition, although not shown in the drawings, according to an embodiment, the electronic device 100 may correct the guide GUI or may provide a guide UI recommending a projection position on the basis of at least one of the posture information of the electronic device 100 or state information of the projection surface, acquired through the sensor (not shown).

As an example, the guide GUI may be required to be corrected based on a posture of the electronic device 100 (or the camera 110) while capturing the image. The guide GUI may not be provided as the user desires if the user holds the electronic device 100 obliquely and captures the image. In this case, the electronic device 100 may correct coordinate information of the guide GUI to be perpendicular to the direction of gravity on the basis of the posture information. Here, the posture information may include at least one of roll information, pitch information, or the yaw information. As an example, the roll information or the pitch information may be acquired through an acceleration sensor (or accelerometer) included in the user terminal 200. In addition, the yaw information may be acquired by the electronic device 100 on the basis of angle of view information of the camera used to capture the projection surface.

As another example, the electronic device 100 may analyze the captured image, and provide an area other than a corresponding area as a recommended position if a pattern, distortion, or the like is identified on the projection surface. Recommended information may include a reason for recommending the corresponding area, or may simply provide a recommendation guide GUI. As an example, the recommended information may be provided only on the recommendation guide GUI if the recommendation guide GUI and a guide GUI for a user setting are provided together. As another example, the electronic device 100 may initially provide the guide GUI for the user setting at the recommended position without providing the recommended information separately. As another example, the electronic device 100 may also provide the plurality of recommended GUIs at the plurality of recommended positions together with a recommendation ranking.

According to the various embodiments described above, a screen distortion phenomenon may be easily improved using the mobile device camera if the projection screen appears distorted due to a difference between the user position and a projection angle.

In addition, user experience UX may be improved by switching an existing projector-centered screen setting to a user-centered automatic optimization setting via multi device experience (MDE) connection.

In addition, the user experience UX may be improved because the projection screen may be adjusted immediately via mobile interaction instead of an existing cumbersome remote control screen adjustment.

In addition, the present disclosure may allow the user to easily manipulate the projection screen via a familiar touch manipulation on the mobile device, and provide interaction enabling screen manipulation without viewing a mobile device screen.

In addition, the present disclosure may provide a screen suitable for the viewing angle and position of each user in case of using the split multi-user screen.

In addition, the present disclosure may provide simple touch interaction to simply perform the keystone correction in a scenario using the plurality of projector devices (edge blending).

In addition, the present disclosure may recognize an image of the surrounding environment and adjust the screen placement based on the surrounding object, thus satisfying a user need to view the screen at the largest possible size by avoiding the surrounding obstacles.

Meanwhile, the methods according to the various embodiments of the present disclosure described above may be implemented in the form of an application which may be installed on an existing electronic device. Alternatively, the methods according to the various embodiments of the present disclosure described above, for example, determining the arrangement state of GUI items based on a viewing angle area, may be performed using a deep learning-based artificial neural network (or deep artificial neural network), i.e., learning network model.

In addition, the methods according to the various embodiments of the present disclosure described above may be implemented only by software upgrade or hardware upgrade of the existing electronic device.

In addition, the various embodiments of the present disclosure described above may be performed using an embedded server included in the electronic device, or the external server of the electronic device.

Meanwhile, according to an embodiment of the present disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic device (e.g., electronic device 100) according to the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to an embodiment of the present disclosure, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™. In case of the online distribution, at least a portion of the computer program product may be at least temporarily stored or temporarily generated on a storage medium such as the memory of a manufacturer server, an application store server, or a relay server.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic device comprising:
a camera;
a display;
a communication interface;
a memory configured to store at least one instruction; and
at least one processor, configured to be connected to the camera, the display, the communication interface, and the memory, and while connected, the at least one processor configured to control the electronic device to:
control the display to display an image obtained by the camera based on a projection surface onto which a test image including a plurality of markers is projected being obtained by the camera,
obtain fourth information indicating a position of a maximum projection area within the obtained image based on first information, second information, and third information, the first information indicating positions of the plurality of markers, the second information indicating the position of the maximum projection area are received from a projector device via the communication interface and the third information based on the obtained image,
control the display to display a guide graphical user interface (GUI) guiding a projection area based on the obtained fourth information, and
obtain keystone correction information, which enables projection of an image corresponding to a guide area corresponding to the guide GUI, to be transmitted to the projector device via the communication interface.

2. The electronic device as claimed in claim 1, wherein the fourth information includes coordinate information of a four-vertex area indicating the position of the maximum projection area,
the at least one processor is configured to display the guide GUI without deviating from the maximum projection area based on the fourth information, environmental information included in the obtained image, and a predetermined projection area ratio, and
the guide GUI has a rectangular line shape.

3. The electronic device as claimed in claim 1, wherein the at least one processor is configured to control the communication interface to transmit spatial information from which the keystone correction information is obtained to the projector device together with the keystone correction information, and
the spatial information includes information on a distance between the projector device and the electronic device and information on a direction of the electronic device relative to the projector device.

4. The electronic device as claimed in claim 1, wherein the at least one processor is configured to obtain the keystone correction information for a projection screen relatively close to the electronic device among a plurality of projection screens provided the test image included in the obtained image includes the plurality of projection screens, and
the plurality of projection screens respectively provide a plurality of first content provided from a plurality of sources or a plurality of second content provided from a single source.

5. The electronic device as claimed in claim 4, wherein the at least one processor is configured to obtain the keystone correction information for any one of the plurality of projection screens regardless of a distance between the plurality of projection screens and the electronic device provided the any one of the plurality of projection screens includes content provided from the electronic device.

6. The electronic device as claimed in claim 1, wherein the at least one processor is configured to
control the display to display a user interface (UI) screen for adjusting magnification of at least one of a first projection area corresponding to a first projector device and a second projection area corresponding to a second projector device provided the obtained image including a first test image projected from the first projector device and a second test image projected from the second projector device is obtained, and
obtain the keystone correction information for adjusting the magnification of the first projection area and the second projection area to a level that is same based on a user command input through the UI screen.

7. The electronic device as claimed in claim 6, wherein the at least one processor is configured to control the display to provide a UI guiding a position movement of at least one of the first projector device or the second projector device provided the first projection area and the second projection area are identified as being incapable of overlapping with each other.

8. The electronic device as claimed in claim 1, wherein the at least one processor is configured to control the display to display a first guide GUI guiding a current projection area and a second guide GUI guiding the maximum projection area, and
provide feedback on an adjustable area of the first guide GUI based on the second guide GUI provided at least one of a size, a position, or a direction of the first guide GUI is adjusted based on a user command, and
the feedback includes at least one of visual feedback, sound feedback, or haptic feedback.

9. The electronic device as claimed in claim 1, wherein the at least one processor is configured to
identify a position of an object included in the obtained image, and
control the display to display an adjusted guide GUI that is automatically adjusted based on the identified position of the object provided at least one of a size or a position of the guide GUI is manually adjusted by a user input.

10. The electronic device as claimed in claim 1, further comprising a sensor,
wherein the at least one processor is configured to correct the guide GUI or provide the guide GUI based on at least one of environmental information of the projection surface or posture information of the electronic device, obtained through the sensor.

11. A method for controlling an electronic device, the method comprising:
displaying an image obtained by a camera based on a projection surface onto which a test image including a plurality of markers is projected being obtained by the camera;
obtaining fourth information indicating a position of a maximum projection area within the obtained image based on first information, second information, and third information, the first information indicating positions of the plurality of markers, the second information indicating the position of the maximum projection area are received from a projector device and the third information being based on the obtained image;
displaying a guide graphical user interface (GUI) guiding a projection area based on the obtained fourth information; and
obtaining keystone correction information, which enables projection of an image corresponding to a guide area corresponding to the guide GUI, to be transmitted to the projector device.

12. The method as claimed in claim 11, wherein the fourth information includes coordinate information of a four-vertex area indicating the position of the maximum projection area,
in the displaying of the GUI,
the guide GUI is displayed without deviating from the maximum projection area based on the fourth information, environmental information included in the obtained image, and a predetermined projection area ratio, and
the guide GUI has a rectangular line shape.

13. The method as claimed in claim 11, further comprising transmitting spatial information from which the keystone correction information is obtained to the projector device together with the keystone correction information, and
the spatial information includes information on a distance between the projector device and the electronic device and information on a direction of the electronic device relative to the projector device.

14. The method as claimed in claim 11, wherein in the transmitting of the obtained keystone correction information to the projector device,
the keystone correction information is obtained for a projection screen relatively close to the electronic device among a plurality of projection screens provided the test image included in the obtained image includes the plurality of projection screens, and
the plurality of projection screens respectively provide a plurality of first content provided from a plurality of sources or a plurality of second content provided from a single source.

15. The method as claimed in claim 14, wherein in the transmitting of the obtained keystone correction information to the projector device comprising:
obtaining the keystone correction information for any one of the plurality of projection screens regardless of a distance between the plurality of projection screens and the electronic device provided the any one of the plurality of projection screens includes content provided from the electronic device.

16. The method as claimed in claim 11, further comprising:
displaying a user interface (UI) screen for adjusting magnification of at least one of a first projection area corresponding to a first projector device and a second projection area corresponding to a second projector device provided the obtained image including a first test image projected from the first projector device and a second test image projected from the second projector device is obtained; and
obtaining the keystone correction information for adjusting the magnification of the first projection area and the second projection area to a level that is same based on a user command input through the UI screen.

17. The method as claimed in claim 16, further comprising:
providing a UI guiding a position movement of at least one of the first projector device or the second projector device provided the first projection area and the second projection area are identified as being incapable of overlapping with each other.

18. The method as claimed in claim 11, further comprising:
displaying a first guide GUI guiding a current projection area and a second guide GUI guiding the maximum projection area; and
providing feedback on an adjustable area of the first guide GUI based on the second guide GUI provided at least one of a size, a position, or a direction of the first guide GUI is adjusted based on a user command, and
wherein the feedback includes at least one of visual feedback, sound feedback, or haptic feedback.

19. The method as claimed in claim 11, further comprising:
identifying a position of an object included in the obtained image; and
displaying an adjusted guide GUI that is automatically adjusted based on the identified position of the object provided at least one of a size or a position of the guide GUI is manually adjusted by a user input.

20. A non-transitory computer-readable medium storing a computer instruction that causes an electronic device to perform an operation when executed by a processor of the electronic device, the operation comprising:
displaying an image obtained by a camera provided a projection surface onto which a test image including a plurality of markers is projected being obtained by the camera,
obtaining fourth information indicating a position of a maximum projection area within the obtained image based on first information, second information, and third information, the first information indicating positions of the plurality of markers and the second information indicating the position of the maximum projection area are received from a projector device and the third information being based on the obtained image,
displaying a guide graphical user interface (GUI) guiding a projection area based on the obtained fourth information, and
obtaining keystone correction information, which enables projection of an image corresponding to a guide area corresponding to the guide GUI, to be transmitted to the projector device.
